(19) United States
(12) Patent Application Publication
(10) Pub. No.: US 2017/0049130 A1
(43) Pub. Date: Feb. 23, 2017

(54) ANIMAL FEED

(71) Applicant: WILSON PASTORAL AUSTRALIA PTY LTD, Fullarton, South Australia (AU)

(72) Inventors: Brian Leonard WILSON, South Australia (AU); Jillian Louise WILSON, South Australia (AU)

(21) Appl. No.: 15/115,534

(22) PCT Filed: Jan. 29, 2015
(86) PCT No.: PCT/AU15/00039

§ 371 Date: Jul. 29, 2016

(30) Foreign Application Priority Data
Jan. 29, 2014 (AU) 2014900263
Aug. 4, 2014 (AU) 2014903004

(51) Int. Cl. A23K 10/30; A23K 20/163; A23K 50/10; A23K 50/20; A23K 10/37; A23K 20/158

(52) U.S. Cl. CPC A23K 10/30; A23K 10/37; A23K 20/158; A23K 50/10; A23K 50/20; A23K 20/163

(57) ABSTRACT

Disclosed herein is a solid feed formulation for feeding to livestock. The formulation comprises comminuted saltbush or bluebush plant material as a protein component. Optionally, the formulation further comprises an energy component, such as feed barley, a vegetable oil, plant material from plants of the genus Artemisia, and/or one or more excipients or additives.

### PRIORITY DOCUMENTS

The present application claims priority from Australian Provisional Patent Application No. 2014900263 titled “ANIMAL FEED” and filed on 29 Jan. 2014 and Australian Provisional Patent Application No. 2014903004 titled “ANIMAL FEED” and filed on 4 Aug. 2014, the contents of which are hereby incorporated by reference in their entirety.

### TECHNICAL FIELD

The present invention relates to feeds for animals (e.g. domesticated animals and those held in captivity), including ruminants such as sheep, cattle and goats, as well as other animals such as horses (e.g. race horses), pigs, and poultry.

### BACKGROUND

A rapid increase in world population has led to a rapidly increasing demand for food protein and new ways are needed to increase the supply of food proteins. Of particular importance is the production of animals that contain proteins having essential amino acids required by humans. Innovative, new ways of feeding livestock animals will assist in increasing the production of such animals.

Animal feeds are foods given to animals in the course of animal husbandry. Animal feeds may be in the form of fodder, which is a food given to the animals, or forage which is a food the animals have to forage for themselves. Unless otherwise noted, the term “animal feed” when used herein means fodder.

Animal feeds can include hay, straw, silage, compressed and pelleted feeds, oils and mixed rations, and sprouted grains and legumes. Animal feeds need to satisfy the animals need for protein, energy, roughage and minerals. Common feed stuffs used in feeds include: grain, molasses, silage for energy; meals such as cotton seed meal, lupins, silage for protein; hay and silage for roughage; minerals such as lime; starch, vitamins and trace elements such as phosphorous.

One problem with known animal feeds is they are formed from feed stuffs that have other uses including in the human food chain (eg. grains including maize, soybean, wheat, oats, barley, and rice) and/or they add substantially to the cost of producing the animal feed.

There is thus a need to provide an animal feed that is economical to produce and/or provides an alternative to existing animal feeds.

### SUMMARY

The present invention arises from our research in to the use of saltbush in animal feeds.

According to a first aspect, there is provided a solid feed formulation for feeding to livestock, said formulation comprising comminuted saltbush or bluebush plant material as a protein component.

In certain embodiments, the solid feed formulation further comprises an energy component. The energy component may be a plant based carbohydrate source, an energy component that provides roughage or a sugar based carbohydrate source.

In certain embodiments, the solid feed formulation is in the form of a dry mix and the energy component comprises:
(a) 20% to 70% (by weight) of a plant based carbohydrate source; and
(b) 20% to 40% (by weight) of an energy component that provides roughage for digestion.

In certain other embodiments, the solid feed formulation is in the form of a pellet and the energy component comprises:
(a) 20% to 70% (by weight) of a plant based carbohydrate source;
(b) 20% to 40% (by weight) of an energy component that provides roughage for digestion; and
(c) 1% to 10% (by weight) of a sugar based carbohydrate source.

In certain embodiments, the solid feed formulation further comprises plant material from plants of the genus Artemisia.

According to a second aspect, there is provided a method of feeding livestock animals, the method comprising feeding the solid feed formulation of the first aspect to an animal.

According to a third aspect, there is provided a method of forming a solid feed formulation for feeding to livestock, said formulation comprising comminuted saltbush or bluebush plant material as a protein component, the method comprising comminuting dried saltbush or bluebush plant material and forming a solid feed formulation therefrom.

### DESCRIPTION OF EMBODIMENTS

Disclosed herein is a solid feed formulation for feeding to livestock, said formulation comprising comminuted saltbush or bluebush plant material as a protein component.

The solid feed formulation may be in any solid form that is suitable for intensive feeding such a dry feed, meal, pellets, crumbles, grains, extruded or expanded grains, tablets or powder. The solid feed formulation provides sufficient nutritional value to allow for growth and maintenance of adequate body conditions of an animal.

The solid feed formulation may be used in any setting in which livestock are fed including, but not limited to, feedlots, farms, paddocks, transport vehicles, ships, etc.

Saltbush is a large branched shrub that grows in arid and semi-arid habitats. It is especially common in saline areas. The term “saltbush” used herein includes within its scope:
members of the genera Atriplex, including A. amnicola (river saltbush), A. nummularia (old man saltbush), A. vesicularia (bladder saltbush), A. undulata (wavy leaf saltbush), A. semibaccata (creeping saltbush), A. cinerea (grey saltbush), A. stipitata (kidney saltbush), and A. lentiformis (quailbush);
members of the genera Enchylaena, including, E. tomentose (ruby saltbush, barrier saltbush);
members of the genera Maireana, including M. sedifolia (pearl saltbush);
members of the genera Einadia, including E. hastate (berry saltbush) and E. nutans (climbing or nodding saltbush); and
Chenopodium murale (berry saltbush) and Sarcobatus vermiculatus (greasewood, seepwood, or saltbush).

The term “bluebush” used herein includes within its scope members of the genera Maireana, including M. pyramidata (black bluebush), M. aphylla (leafless bluebush), M. georgei (slit-wing bluebush or satiny bluebush), M. sedifolia (pearl bluebush), and M. brevifolia (small leaf bluebush).

In the past, river saltbush and old man saltbush in particular have been used as forage feeds for livestock animals. These plants have typically been used to provide a forage feed with high levels of crude protein and vitamin E for sheep during autumn when annual pastures are dead and of poor nutritional value.

Saltbush and bluebush grow throughout Australia on less productive saline areas and drier, less reliable rainfall. The plants require no fertiliser or chemicals and can be certified organic. Thus, the present invention provides a means for producing feed formulations from plant materials grown on less arable land. The saltbush and bluebush plant material in the present feed formulations replace more expensive inputs in known stock feed pellets such as Lucerne and clover hay.

The saltbush or bluebush plant material can be any part of the plant. In certain embodiments, the saltbush or bluebush plant material comprises leaves and/or stems.

Saltbush and bluebush are high in crude protein. The protein content of the comminuted saltbush or bluebush plant material is preferably from (by weight) about 10% to about 30%, such as about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29% or about 30%. The protein content of the saltbush or bluebush plant material can be determined by NIR which tests the protein, moisture and other calibrated readings suitable for the pellets and livestock feed. At different times of the year the saltbush or bluebush plant material may contain different protein levels.

As used herein, the term “about” when used in reference to a value means the actual value is within ±30%, ±20% or ±10% of the stated value.

Saltbush or bluebush plant material can be cut from plants using any suitable method. The plant material is then preferably dried before being comminuted. The plant material can be dried by any suitable method including air drying or drying using a drying apparatus. The plant material is then comminuted. The plant material can be comminuted by grinding, chopping, dismembering or another suitable process. Any of the devices known to the person skilled in the art can be used to comminute the plant material, such as shredders, choppers, (cutting) mills, and dicers. The plant material may be comminuted in several stages, from coarse to fine.

The amount of comminuted saltbush or bluebush plant material present in the solid feed formulation may be from about 1% to about 100% (by weight), such as about 20% to about 60% (by weight). In certain embodiments, the amount (by weight) of comminuted saltbush or bluebush plant material present in the solid feed formulation is about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59% or about 60%.

In certain embodiments, the solid feed formulation comprises 95% to 100% (by weight) saltbush or bluebush plant material. In these embodiments, the feed formulation may be mixed with other feed components, such as an energy component and/or a carbohydrate source, before feeding to animals. In these embodiments, the saltbush or bluebush plant material is the main component of the feed formulation but it may also contain a binding material (e.g. to assist in the formation of pellets), barley, hay or straw.

Saltbush has a high vitamin E content and therefore it is also a source of beneficial vitamins and minerals for the health of the animals and the quality of the meat they produce.

In specific embodiments, the saltbush or bluebush plant material has a protein content of about 10 to 30% (by weight) and is present in the final solid feed formulation in an amount of about 30% (by weight). It will be appreciated that the amount of saltbush or bluebush plant material present in the final solid feed formulation may be varied depending on the protein content of the material used which, in turn, can vary depending on where the saltbush or bluebush is grown and the growing conditions from season to season.

In certain embodiments, the solid feed formulation further comprises an energy component.

The amount of the energy component present in the solid feed formulation will depend, at least in part, on the digestible energy of the component use but will typically be from about 10% to about 90% (by weight). In certain embodiments, the amount (by weight) of the energy component present in the solid feed formulation is about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 8% or about 90%.

The energy component may be a carbohydrate source. The carbohydrate source may comprise one or more complex carbohydrates and/or one or more simple carbohydrates, such as sugars, starches, cellulose and cellulose containing materials, hemicellulose and hemicellulose containing materials, and lignin and lignin containing materials. The carbohydrate source may be a plant based material. Suitable plant based carbohydrate sources include: hay; greenfeed, including barley and oats; silage, including barley and oats; straw, including barley, oats, and wheat; and grains, including barley, oats, wheat, corn, soybeans, and sorghum. Conveniently, the carbohydrate source comprises one or more feed grains. Suitable feed grains include barley, oats, wheat, rye, triticale, corn, soybeans, sorghum, vetch, field peas, faba beans, chick peas, lentils, lupins or any other legumes.

The plant based carbohydrate source may be present in the formulation in an amount of about 10% to about 90% by weight. In certain embodiments, the amount (by weight) of the plant based carbohydrate source present in the solid feed formulation is about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 8% or about 90%.

In specific embodiments, the plant based carbohydrate source is feed barley. The feed barley is present in the formulation in an amount of about 30% by weight.

The energy component may also provide roughage for digestion. Energy components that can provide roughage include barley, oat and wheat straw. In specific embodiments, the energy component that provides roughage is barley straw.

The energy component that provides roughage may be present in the formulation in an amount of about 20% to about 40% by weight. In certain embodiments, the amount (by weight) of the energy component that provides roughage present in the solid feed formulation is about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39% or about 40%.

In specific embodiments, the energy component that provides roughage is barley straw. The barley straw is present in the formulation in an amount of about 30% by weight.

In certain embodiments, the energy component further comprises a sugar based carbohydrate source. Suitable sugar based carbohydrate sources include molasses (i.e. treacle), honey, sweet sorghum syrup, barley malt syrup, maple syrup, sugar, corn syrup, date syrup and/or any other sugar based carbohydrate source.

The sugar based carbohydrate source may be present in the formulation in an amount of about 1% to about 10% by weight. In certain embodiments, the amount (by weight) of the energy component that provides roughage present in the solid feed formulation is about 1%, about 2%, about 3%, about 4%, about 5%, about 6%, about 7%, about 8%, about 9% or about 10%.

In specific embodiments, the sugar based carbohydrate source comprises molasses. The molasses is present in the formulation in an amount of about 5% by weight.

Advantageously, the sugar based carbohydrate source such as molasses may also act as a binder for solid feed formulations that are in the form of pellets.

Thus, it will be apparent from the foregoing discussion that embodiments of the present invention provide a solid feed formulation for feeding to livestock, said formulation comprising:
(a) 1 to 100% (by weight) of a comminuted saltbush or bluebush plant material as a protein component;
(b) optionally, about 10% to about 90% (by weight) of an energy component; and
(c) optionally, excipients.

In certain embodiments, the solid feed formulation is a dry mix. In these embodiments, the energy component comprises:
(a) 10% to 90% (by weight) of a plant based carbohydrate source; and
(b) 20% to 40% (by weight) of an energy component that provides roughage for digestion.

In other embodiments, the solid feed formulation is a pellet. In these embodiments, the energy component comprises:
(a) 20% to 70% (by weight) of a plant based carbohydrate source;
(b) 20% to 40% (by weight) of an energy component that provides roughage for digestion; and
(c) 1% to 10% (by weight) of a sugar based carbohydrate source.

In certain embodiments in which the solid feed formulation is a pellet the formulation may contain excipients. For example, the formulation may contain an oil to provide moisture to the pellet, to assist in binding the components of the pellet and also provide a source of fat. Oils (fats) in the formulation can also aid in the absorption and transportation of fat-soluble vitamins (A, D, E, K). Saltbush and bluebush are known to have high vitamin E content and, for this reason, the use of an oil in the formulation may be particularly beneficial. The oil may be present in a pelleted solid feed formulation in an amount of from about 1% to about 10% by weight.

In specific embodiments of a pelleted solid feed formulation the oil is a vegetable oil and is present in an amount of up to about 5% by weight.

In certain embodiments, the solid feed formulation further comprises plant material from plants of the genus Artemisia. Common names for various species in the genus include mugwort, wormwood, and sagebrush and notable species include A. vulgaris (common mugwort), A. tridentata (big sagebrush), A. annua (sagewort), A. absinthum (wormwood), A. dracunculus(tarragon), and A. abrotanum (southernwood). In specific embodiments, the solid feed formulation comprises plant material from A. arborescens plants which are commonly referred to as “wormwood” or “tree wormwood”. The plant material from plants of the genus Artemisia naturally suppresses internal parasites in ruminant animals. The plant material can be comminuted, added to the other ingredients, and then pelleted as described herein. The amount of plant material from plants of the genus Artemisia can be determined empirically by monitoring faecal egg counts from animals fed with the solid feed formulation and then adjusting the amount of Artemisia plant material accordingly. For example, the Artemisia plant material may be present in the formulation in an amount of at least about 1% to about 20% by weight, such as about 1%, 2%, 3%, 4%, 5%, 6%, 7%, 8%, 9%, 10%, 11%, 12%, 13%, 14%, 15%, 16%, 17%, 18%, 19% or 20% by weight. In certain embodiments the Artemisia plant material is present in the formulation in an amount of at least 5% by weight. The amount of Artemisia plant material may be higher depending on how severe the worm burden is in a particular animal. This can be determined by individual test results.

Substances that supplement or add to the nutritional properties of the formulation, assist in the manufacture of the formulation or alter a physical property of the formulation may be used as excipients in the formulation. Excipients for this purpose include (but are not limited to) vitamins, minerals, preservatives, antibiotics, fermentation products, fats, other essential ingredients, colouring agents, fillers, etc. Specific substances that may be added include substances of a marine origin, bicalcium phosphate, calcium carbonate, calcium bicarbonate, magnesium oxide, polyvitamins, minerals or any other type of mineral or microingredient, essential amino acids such as lysine, methionine, tryptophan, threonine, and derivatives or combinations thereof by way of example, the solid feed formulation may contain a colouring agent to identify the type, source or some other characteristic of the formulation, or to enhance consumption of the feed by the animal.

Pellets can be formed using standard techniques using conventional equipment. The resulting pellets will generally be dried and packaged for storage and distribution.

Optionally, the solid feed formulation may be partially fermented to improve the nutritional content of the formulation. Alternatively, individual components of the solid feed formulation may be partially fermented prior to incorporation into the formulation in order to improve the nutritional content of the formulation. Any of the methods for producing partially fermented feeds known for this purpose in the art can be used to produce a partially fermented formulation. For example, individual components, mixtures thereof or the final formulation may be treated with an enzyme capable of reducing plant tissue such as proteins, starches, sugars, pectins, cellulose, hemicellulose, and lignin. Examples of such enzymes are proteases, amylases, dextranases, pectinases, cellulases, xylanases, mannanases and ligninases.

The solid feed formulation may be particularly suitable for feeding ruminants including sheep and cattle. However, it is contemplated that it could be fed to all livestock (e.g. pigs, poultry), hoofed animals (e.g. goats, horses) and also to pets. It may be particularly suitable for race horses.

The nature and proportion of the components in the solid feed formulation depend on many factors, for example, the type of animal, the age of the animal, nutritional requirements of the animal, individual feed producer preference and the cost of ingredients. The nature and proportion of the components can be determined using known nutritional information by animal nutritionists and the like using standard techniques.

The invention also provides a method of feeding livestock animals, the method comprising feeding the solid feed formulation described herein to an animal.

The invention also provides a method of forming a solid feed formulation for feeding to livestock, said formulation comprising comminuted saltbush or bluebush plant material as a protein component, the method comprising comminuting dried saltbush or bluebush plant material and forming a solid feed formulation therefrom.

The method may comprise a further step of mixing the comminuted saltbush or bluebush plant material with an energy component and, optionally, excipients prior to forming the solid feed formulation.

### EXAMPLES

### Example 1

### Preparation of Saltbush Pellets

The following ingredients we used a solid feed formulation in the form of pellets:

| | Amount (by weight | |
|---|---|---|
| Component | of final formulation) | |
| Dried saltbush leaves | 30% | Protein content |
| and stems | | approximately 25% |
| Feed barley | 30% | Protein 9.5% being a large |
| | | plump grain with a test |
| | | weight of 67 kg to the hl to |
| | | provide adequate energy |
| Barley straw | 30% | Provides roughage for |
| | | digestion |
| Golden Syrup ™ | 5% | Binds the pellet and |
| (molasses) | | provides additional energy |
| Vegetable oil | 5% | Provides moisture and |
| | | binding component |

Leaves and stems were collected from saltbush plants and then dried. The dried leaves, feed barley and barley straw were chopped and ground to a consistency suitable for making pellets. The chopped materials were then mixed together and the molasses and vegetable oil were added along with a suitable amount of warm water at 60 degrees to assist in the mixing and pelleting process. The mixture obtained was then either rolled into a pellet form or processed through an electric mincer to produce a pellet form. The pellets were then either sun dried or dried in an oven.

The pellets were readily consumed by sheep.

### Example 2

### Preparation of Saltbush Dry Feed

The following ingredients we used a solid feed formulation in the form of a dry mix:

| | Amount (by weight | |
|---|---|---|
| Component | of final formulation) | |
| Dried saltbush leaves | 33.3% | Protein content |
| and stems | | approximately 25% |
| Feed barley | 33.3% | Protein 9.5% being a large |
| | | plump grain with a test |
| | | weight of 67 kg to the hl to |
| | | provide adequate energy |
| Barley straw | 33.3% | Provides roughage for |
| | | digestion |

Leaves and stems were collected from saltbush plants and then dried. The dried leaves, feed barley and barley straw were chopped and ground to a consistency suitable for making a dry feed mix. The chopped materials were then mixed together to provide a dry feed mix. The dry feed mix was readily consumed by sheep.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A solid feed formulation for feeding to livestock, said formulation comprising comminuted saltbush or bluebush plant material as a protein component.

2. The solid feed formulation according to claim 1, wherein the formulation is in the form of a pellet.

3. The solid feed formulation according to claim 1, wherein the formulation is in the form of a dry mix.

4. The solid feed formulation according to any one of the preceding claims, wherein the saltbush is selected from one or more of the group consisting of: Atriplex amnicola (river saltbush) and A. nummularia (old man saltbush).

5. The solid feed formulation according to any one of the preceding claims, wherein the saltbush or bluebush plant material comprises leaves and/or stems.

6. The solid feed formulation according to any one of the preceding claims, wherein the protein content of the comminuted saltbush or bluebush plant material is from (by weight) about 10% to about 30%.

7. The solid feed formulation according to any one of the preceding claims, wherein the amount of comminuted saltbush or bluebush plant material present in the solid feed formulation is from about 1% to 100% (by weight).

8. The solid feed formulation according to any one of the preceding claims, wherein the saltbush or bluebush plant material has a protein content of about 25% (by weight) and is present in the final solid feed formulation in an amount of about 30% (by weight).

9. The solid feed formulation according to any one of the preceding claims, wherein the amount of comminuted saltbush or bluebush plant material present in the solid feed formulation is less than 100% (by weight) and the solid feed formulation further comprises an energy component.

10. The solid feed formulation according to claim 9, wherein the amount of the energy component present in the solid feed formulation is from about 10% to about 90% (by weight).

11. The solid feed formulation according to any one of claims 9 and 10 wherein the energy component is a carbohydrate source.

12. The solid feed formulation according to any one of claims 9 to 11, wherein the carbohydrate source comprises a plant based carbohydrate source.

13. The solid feed formulation according to any one of claims 9 to 12, wherein plant based carbohydrate source is a feed grain.

14. The solid feed formulation according to any one of claims 9 to 13, wherein plant based carbohydrate source is feed barley.

15. The solid feed formulation according to any one of claims 9 to 14, wherein the plant based carbohydrate source is present in the formulation in an amount of about 10% to about 90% by weight.

16. The solid feed formulation according to any one of claims 9 to 15, wherein the energy component is an energy component that provides roughage.

17. The solid feed formulation according to claim 16, wherein the energy component that provides roughage is selected from the group consisting of: barley straw, oat straw, and wheat straw.

18. The solid feed formulation according to any one of claims 16 and 17, wherein the energy component that provides roughage is present in the formulation in an amount of about 20% to about 40% by weight.

19. The solid feed formulation according to any one of claims 9 to 18, wherein the energy component comprises a sugar based carbohydrate source.

20. The solid feed formulation according to claim 19, wherein the sugar based carbohydrate source comprises molasses.

21. The solid feed formulation according to any one of claims 19 and 20, wherein the sugar based carbohydrate source is present in the formulation in an amount of about 1% to about 10% by weight.

22. The solid feed formulation according to any one of claims 1 to 21, further comprising one or more excipients or additives.

23. The solid feed formulation according to any one of claims 9 to 18, wherein the formulation is a dry mix and the energy component comprises:
(a) 10% to 90% (by weight) of a plant based carbohydrate source; and
(b) 20% to 40% (by weight) of an energy component that provides roughage for digestion.

24. The solid feed formulation according to any one of claims 9 to 22, wherein the formulation is a pellet and the energy component comprises:
(a) 20% to 70% (by weight) of a plant based carbohydrate source;
(b) 20% to 40% (by weight) of an energy component that provides roughage for digestion; and
(c) 1% to 10% (by weight) of a sugar based carbohydrate source.

25. The solid feed formulation according claim 24, further comprising vegetable oil.

26. The solid feed formulation according claim 25, wherein the oil is present in the solid feed formulation in an amount of up to about 5% by weight.

27. The solid feed formulation according to any one of claims 1 to 26, further comprising plant material from plants of the genus Artemisia.

28. A method of feeding livestock animals, the method comprising feeding the solid feed formulation of any one of claims 1 to 27 to an animal.

29. A method of forming a solid feed formulation for feeding to livestock, said formulation comprising comminuted saltbush or bluebush plant material as a protein component, the method comprising comminuting dried saltbush or bluebush plant material and forming a solid feed formulation therefrom.

30. The method according to claim 29, further comprising mixing the comminuted saltbush or bluebush plant material with an energy component and, optionally, excipients, prior to forming the solid feed formulation.
